(19) United States
(12) Patent Application Publication
(10) Pub. No.: US 2008/0089621 A1
(43) Pub. Date: Apr. 17, 2008

(54) Bushing assembly for reducing backlash

(76) Inventor: Scott Edward Barry, Lafayette, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/582,614

(22) Filed: Oct. 17, 2006

(51) Int. Cl. F16C 29/00; B21D 53/00

(52) U.S. Cl. 384/10; 29/898.054

(57) ABSTRACT

A bushing for reducing backlash includes a bushing body extending along a central axis, and the bushing body has a central bore extending along the central axis. The bushing body includes a first section, a second section, and a resilient section coupled between the first section and the second section.

### TECHNICAL FIELD

The present invention relates generally to a bushing assembly, and more particularly, to a bushing assembly that reduces backlash.

### BACKGROUND

In many applications, especially in positioning devices such as fine adjustment actuators, it is desirable to have a screw and a matched bushing that can reduce or eliminate backlash. Many anti-backlash mechanisms have been proposed, for example, using materials that may have a long wear life time to make the screw and the bushing, or using washers, or using other mechanisms. However, using long wearing materials may increase the manufacturing cost of the screw and the bushing, and using washers may degrade the accuracy for fine positioning devices. Other conventional anti-backlash devices and methods also fail to provide satisfactory results. Therefore, there is a need for a bushing that can effectively reduce or eliminate backlash, satisfy accuracy requirements, and be inexpensively manufactured.

### SUMMARY OF THE INVENTION

According to some embodiments, the present invention is directed to a bushing for reducing backlash. The bushing may include a bushing body extending along a central axis. The bushing body may have a central bore extending along the central axis, and may include a first section, a second section, and a resilient section coupled between the first section and the second section.

According to some other embodiments, the bushing may include a bushing body extending along a central axis. The bushing body may have an annular wall and a central bore within the annular wall. The central bore may extend along the central axis, and may include an inner circumferential surface having a thread thereon. The bushing body may include a first section, a second section, and an intermediate section between the first section and the second section. The annular wall of the intermediate section may include a spiral shape structure formed by partially removing the annular wall of the intermediate section.

According to some embodiments, the present invention is directed to a bushing assembly for reducing backlash. The bushing assembly may include a first section, a second section, and a resilient section coupled between the first section and the second section.

### BRIEF DESCRIPTION OF THE DRAWINGS

FIG. 1 is a perspective view of an exemplary disclosed bushing according to some embodiments of the invention;

FIG. 2 is a cross-sectional view of an exemplary disclosed bushing according to some embodiments of the invention; and

FIG. 3 is a perspective view of an exemplary disclosed bushing assembly according to some embodiments of the invention.

### DETAILED DESCRIPTION

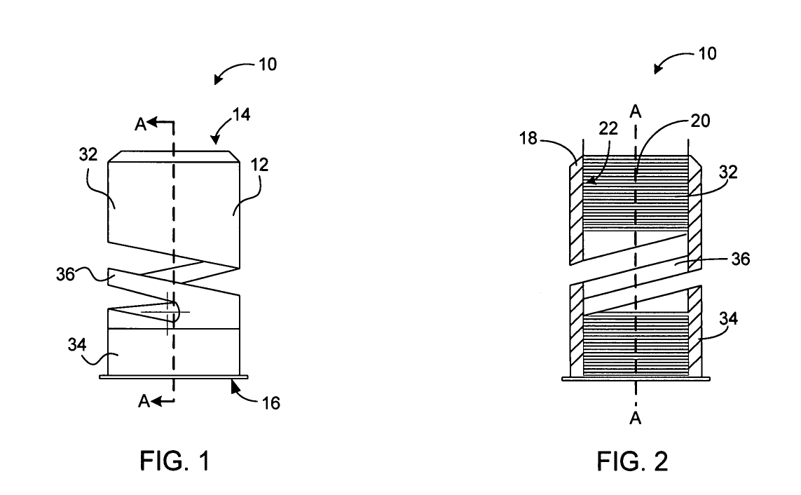

FIG. 1 illustrates a perspective view of an exemplary bushing 10 according to some embodiments of the present invention. The bushing 10 may include a cylindrical body 12 extending along a central axis A between a first end 14 and a second end 16. FIG. 2 illustrates a cross-sectional view of the bushing 10. As shown in FIG. 2, the bushing body 12 may have an annular wall 18 and a central bore 20 within the annular wall 18. The central bore 20 extends along the central axis A. The central bore 20 may include an inner circumferential surface 22 having a thread formed thereon. The central bore 20 is adapted to receive a screw member (not shown) which may have an outer circumferential surface having a thread that is adapted to engage the thread formed on the inner circumferential surface 22 of the bushing 10.

As shown in FIGS. 1 and 2, the bushing 10 may include a first section 32, a second section 34, and an intermediate section 36 between the first section 32 and the second section 34. The intermediate section 36 may include a resilient section. In some embodiments, the first, second, and the intermediate sections 32, 34, and 36 are integrally formed, and the intermediate section 36 may be a spiral spring formed by having the annular wall 18 partially removed, leaving a spiral spring shape structure coupled between the first section 32 and the second section 34. The bushing 10 may be made from a resilient material, for example, a metal. Thus, the spiral spring shape structure 36 may be resilient and function like a spring. As shown in FIG. 2, in some embodiments, the central bore 20 passes through the first section 32 and the second section 34. In use, a leading end of a screw can pass through the first section 32, and can extend into the second section 34. During securing the leading end of the screw in the second section 34, the resilient section 36 may be compressed by the first section 32 and the second section 34. The compressed resilient section 36 may provide a constant preload pressure to the threaded screw, and thus may reduce the backlash of the screw inserted therein.

FIG. 2 shows that the central bore 20 passing through the second section 34 of the bushing 10, and the entire inner circumferential surface within the first section 32 and the second section 34 has a thread formed thereon. However, a person skilled in the art should appreciate that the second section 34 may have a central bore that extends into part of the second section 34, and may have a thread on part of the inner circumferential surface.

In some embodiments, the spiral spring shape structure 36 is formed by removing part of the bushing body 12, for example, by cutting away part of the annular wall 18 of the bushing body 12. In some other embodiments, the bushing 10 may employ other a resilient section coupled between the first section 32 and the second section 34. For example, the bushing 10 may have a spring being coupled between the first section 32 and the second section 34.

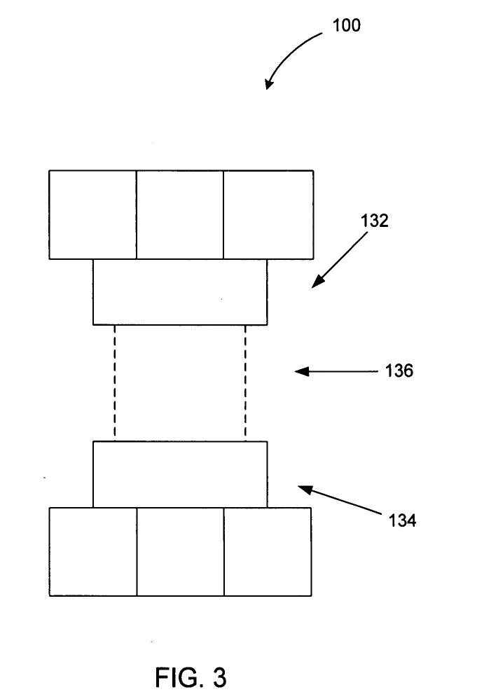

FIG. 3 shows another embodiment of the invention. As shown in FIG. 3, a bushing assembly 100 may include a first section 132, a second section 134, and a resilient section 136 between the first section 132 and the second section 134. The first section 132 may be a nut or a washer. The second section 134 may be a nut or a washer. The resilient section 136 may be a spring coupled between the first section 132 and the second section 134.

It will be apparent to those skilled in the art that various modifications and variations can be made to the bushing for reducing backlash. Other embodiments will be apparent to those skilled in the art from consideration of the specification and practice of the disclosed bushing for reducing backlash. It is intended that the specification and examples be considered as exemplary only, with a true scope being indicated by the following claims and their equivalents.

What is claimed is:

1. A bushing for reducing backlash comprising:
a bushing body extending along a central axis, the bushing body having a central bore extending along the central axis,
wherein the bushing body includes a first section, a second section, and a resilient section coupled between the first section and the second section.

2. The bushing of claim 1, wherein central bore includes an inner circumferential surface having a thread thereon.

3. The bushing of claim 1, wherein the first section, the second section, and the a resilient section comprise an integral structure.

4. The bushing of claim 3, wherein the a resilient section includes a spiral spring formed by partially removing walls of the bushing body.

5. The bushing of claim 1, wherein the central bore extends at least partially into the second section.

6. The bushing of claim 1, wherein the central bore extends through the first section and the second section.

7. A bushing for reducing backlash comprising:
a bushing body extending along a central axis, the bushing body having an annular wall and a central bore within the annular wall, the central bore extending along the central axis, the central bore including an inner circumferential surface having a thread thereon,
the bushing body including a first section, a second section, and an intermediate section between the first section and the second section, wherein the annular wall includes a spiral shape structure formed by partially removing the annular wall of the intermediate section.

8. The bushing of claim 7, wherein the central bore extends at least partially into the second section.

9. The bushing of claim 7, wherein the central bore extends through the first section and the second section.

10. The bushing of claim 7, wherein the bushing body is made from a resilient material.

11. The bushing of claim 10, wherein the bushing body is made from a metal.

12. A method of making a bushing comprising:
providing a bushing body, the bushing body extending along a central axis, and having an annular wall and a central bore within the annular wall; and
partially removing the annular wall of an intermediate section of the bushing body to form a spiral shape structure in the intermediate section of the bushing body.

13. The bushing of claim 12, wherein central bore including an inner circumferential surface having a thread thereon.

14. The bushing of claim 12, wherein the bushing body is made from a resilient material.

15. The bushing of claim 14, wherein the bushing body is made from a metal.

16. A bushing assembly for reducing backlash comprising:
a first section, a second section, and a resilient section coupled between the first section and the second section.

17. The bushing assembly of claim 16, wherein the first section includes a nut.

18. The bushing assembly of claim 16, wherein the second section includes a nut.

19. The bushing assembly of claim 16, wherein the resilient section includes a spring.
